(19) United States
(12) Patent Application Publication
(10) Pub. No.: US 2007/0127233 A1
(43) Pub. Date: Jun. 7, 2007

(54) Wall lamp

(76) Inventor: Hong-Yi Liang, Taichung City (TW)

Correspondence Address: CHARLES E. BAXLEY, ESQ., 90 JOHN STREET, THIRD FLOOR, NEW YORK, NY, 10038, US

(21) Appl. No.: 11/291,715

(22) Filed: Dec. 1, 2005

(51) Int. Cl. F21S 8/00

(52) U.S. Cl. 362/147

(57) ABSTRACT

A wall lamp includes a positioning disk, a plurality of fastening members, a lamp shade, a connecting disk, and a retaining disk. Thus, the connecting disk is locked onto and detached from the positioning disk by rotating the connecting disk relative to the fastening members, so that the wall lamp is assembled and dismantled easily and rapidly, thereby facilitating a user assembling and disassembling the wall lamp, and thereby saving the working time. In addition, the fastening members are wholly hidden in the retaining disk, thereby enhancing the aesthetic quality of the wall lamp.

### BACKGROUND OF THE INVENTION

1. Field of the Invention

The present invention relates to a wall lamp, and more particularly to a wall lamp mounted on a wall or a ceiling.

2. Description of the Related Art

A conventional wall lamp in accordance with the prior art shown in FIG. 9 comprises a fixed disk 14 secured to a ceiling 19 by a plurality of screws 18, a bulb 12 inserted into the ceiling 19, and a shade 16 retained by the fixed disk 14. However, the user has to screw or unscrew the screws 18 to mount or detach the fixed disk 14 so as to replace the bulb 12, thereby greatly causing inconvenience to the user. In addition, the screws 18 protrude from the fixed disk 14, thereby decreasing the aesthetic quality of the wall lamp.

Another conventional wall lamp in accordance with the prior art shown in FIGS. 10 and 11 comprises a fixed disk 14 secured to a ceiling 19 by a plurality of screws 18 and having an outer thread 26, a bulb 12 inserted into the ceiling 19, a rotation ring 22 mounted on the fixed disk 14 and having an inner thread 24 screwed onto the outer thread 26 of the fixed disk 14, and a shade 16 retained by the rotation ring 22. Thus, the user only needs to rotate the rotation ring 22 to remove the rotation ring 22 and the shade 16 from the fixed disk 14 so as to replace the bulb 12. However, the user still has to rotate the rotation ring 22 through multiple cycles, thereby causing inconvenience to the user. In addition, the screws 18 protrude from the fixed disk 14, thereby decreasing the aesthetic quality of the wall lamp.

The closest prior art of which the applicant is aware is disclosed in U.S. Pat. No. 6,457,848B1 to Wolf et al., filed on Sep. 1, 2000, entitled “SNAP TOGETHER DOWN LIGHT FIXTURE”.

### SUMMARY OF THE INVENTION

The present invention is to mitigate and/or obviate the disadvantage of the conventional wall lamp.

The primary objective of the present invention is to provide a wall lamp that is assembled and dismantled easily and rapidly.

Another objective of the present invention is to provide a wall lamp, wherein the connecting disk is locked onto and detached from the positioning disk by rotating the connecting disk relative to the fastening members, so that the wall lamp is assembled and dismantled easily and rapidly, thereby facilitating a user assembling and disassembling the wall lamp, and thereby saving the working time.

A further objective of the present invention is to provide a wall lamp, wherein the fastening members are wholly hidden in the retaining disk, thereby enhancing the aesthetic quality of the wall lamp.

In accordance with the present invention, there is provided a wall lamp, comprising:

a positioning disk secured to a determined surface;

a plurality of fastening members each having a first end formed with a head portion and a second end formed with a shank portion having a diameter smaller than that of the head portion, the shank portion of each of the fastening members being partially extended through the positioning disk and inserted into the determined surface and partially protruded outward from the positioning disk, so that a gap is defined between the head portion of each of the fastening members and the positioning disk;

a connecting disk having a face formed with a plurality of connecting slots each having a first end formed with a receiving portion and a second end formed with a locking portion having a dimension smaller than that of the head portion of each of the fastening members and greater than that of the shank portion of each of the fastening members.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a wall lamp in accordance with the preferred embodiment of the present invention;

FIG. 2 is a plan cross-sectional assembly view of the wall lamp as shown in FIG. 1;

FIG. 3 is a locally enlarged view of the wall lamp as shown in FIG. 2;

FIG. 4 is a bottom plan assembly view of the wall lamp as shown in FIG. 1;

FIG. 5 is a schematic operational view of the wall lamp as shown in FIG. 4;

FIG. 6 is a plan cross-sectional assembly view of a wall lamp in accordance with another preferred embodiment of the present invention;

FIG. 7 is a plan cross-sectional assembly view of a wall lamp in accordance with another preferred embodiment of the present invention;

FIG. 8 is a locally enlarged view of the wall lamp as shown in FIG. 7;

FIG. 9 is a plan cross-sectional assembly view of a conventional wall lamp in accordance with the prior art;

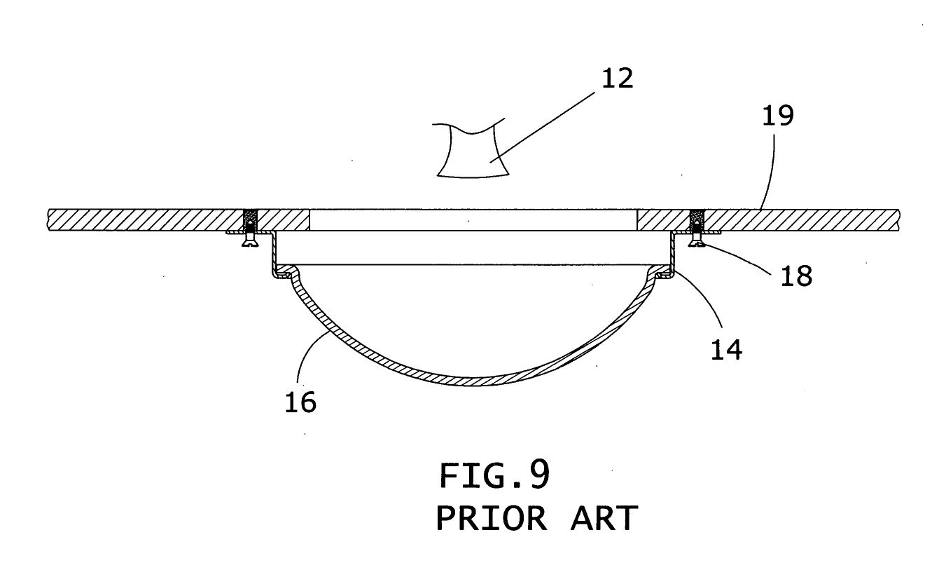

FIG. 10 is a plan cross-sectional assembly view of another conventional wall lamp in accordance with the prior art; and

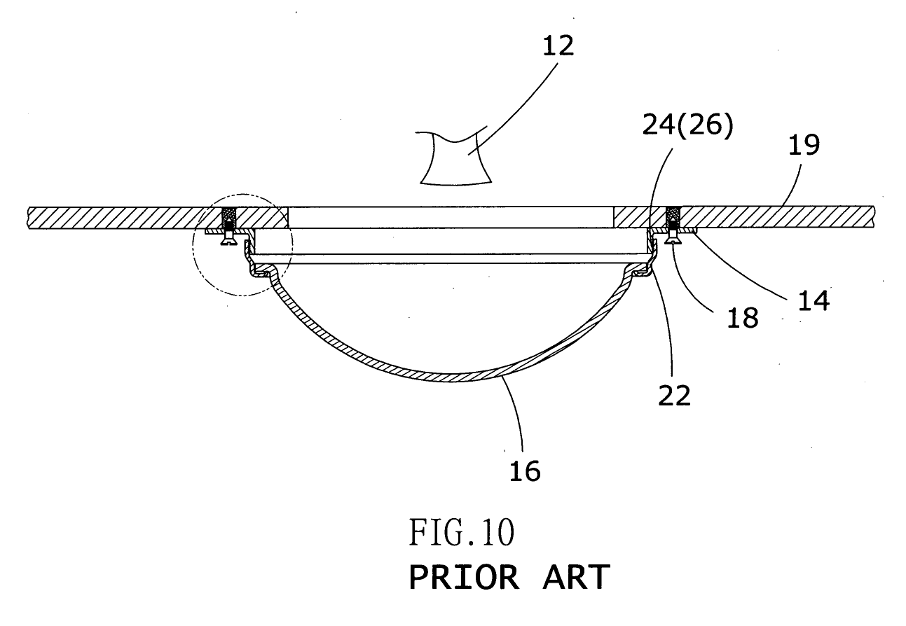

FIG. 11 is a locally enlarged view of the conventional wall lamp as shown in FIG. 10.

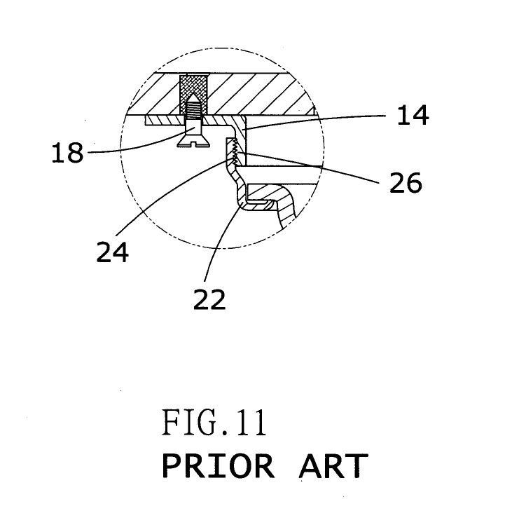

### DETAILED DESCRIPTION OF THE INVENTION

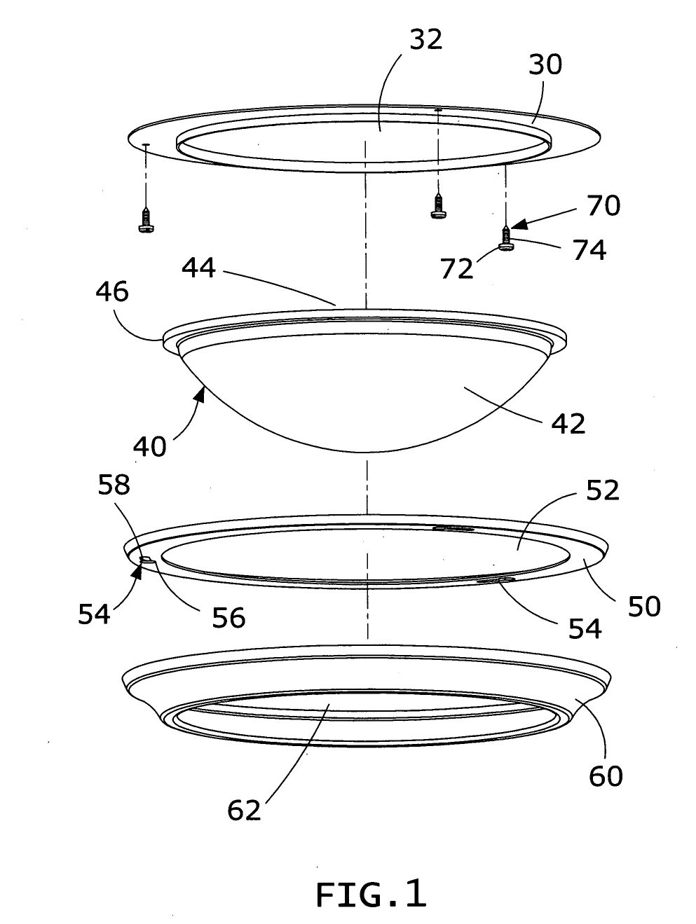

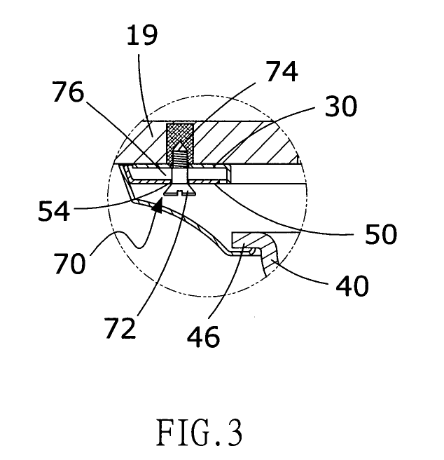

Referring to the drawings and initially to FIGS. 1-5, a wall lamp in accordance with the preferred embodiment of the present invention comprises a positioning disk 30, a lamp shade 40, a connecting disk 50, and a retaining disk 60.

The positioning disk 30 has an annular shape and has a central portion formed with a through hole 32.

The lamp shade 40 has a first end formed with an arc-shaped face 42 and a second end formed with an opening structure 44 having a periphery formed with a radially and outwardly extending annular lip 46.

The retaining disk 60 has an annular shape and has a central portion formed with an opening 62.

The connecting disk 50 has an annular shape and has a central portion formed with an opening 52. The connecting disk 50 has an annular face formed with a plurality of connecting slots 54 each consisting of two holes having different diameters. Each of the connecting slots 54 of the connecting disk 50 has a first end formed with a receiving portion 56 and a second end formed with a locking portion 58 having a dimension (or diameter) smaller than that of the receiving portion 56. In the preferred embodiment of the present invention, the locking portion 58 of each of the connecting slots 54 of the connecting disk 50 is an elongated hole so that the dimension of the locking portion 58 of each of the connecting slots 54 of the connecting disk 50 means a width in the transverse direction of the elongated hole.

Referring to FIGS. 1-3, the positioning disk 30 is secured to a ceiling 19 by a plurality of fastening members 70. Thus, the wall lamp is mounted on the ceiling 19, and the electric bulb 12 of the wall lamp is inserted into the ceiling 19. Each of the fastening members 70 is preferably a locking screw. Each of the fastening members 70 has a first end formed with a head portion 72 and a second end formed with a shank portion 74 having a diameter smaller than that of the head portion 72. The shank portion 74 of each of the fastening members 70 is partially extended through the positioning disk 30 and inserted into the ceiling 19 and partially protruded outward from the positioning disk 30, so that a gap 76 is defined between the head portion 72 of each of the fastening members 70 and the positioning disk 30.

The connecting disk 50 and the retaining disk 60 are integrally combined together by soldering. The lamp shade 40 is mounted in a combination of the connecting disk 50 and the retaining disk 60, and the arc-shaped face 42 of the lamp shade 40 is protruded outward from the opening 62 of the retaining disk 60.

Referring to FIGS. 1-5, the receiving portion 56 of each of the connecting slots 54 of the connecting disk 50 has a diameter greater than that of the head portion 72 of each of the fastening members 70, and the locking portion 58 of each of the connecting slots 54 of the connecting disk 50 has a diameter greater than that of the shank portion 74 of each of the fastening members 70 and smaller than that of the head portion 72 of each of the fastening members 70.

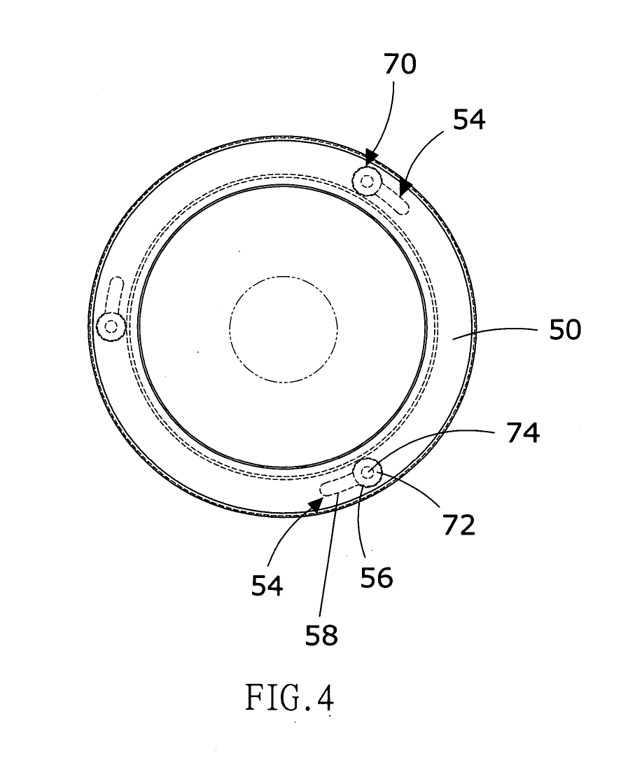

Referring to FIG. 4, when each of the connecting slots 54 of the connecting disk 50 is fitted onto the respective fastening member 70, the receiving portion 56 of each of the connecting slots 54 of the connecting disk 50 aligns with the head portion 72 of the respective fastening member 70, so that the head portion 72 of each of the fastening members 70 can be inserted into the receiving portion 56 of the respective connecting slot 54 of the connecting disk 50.

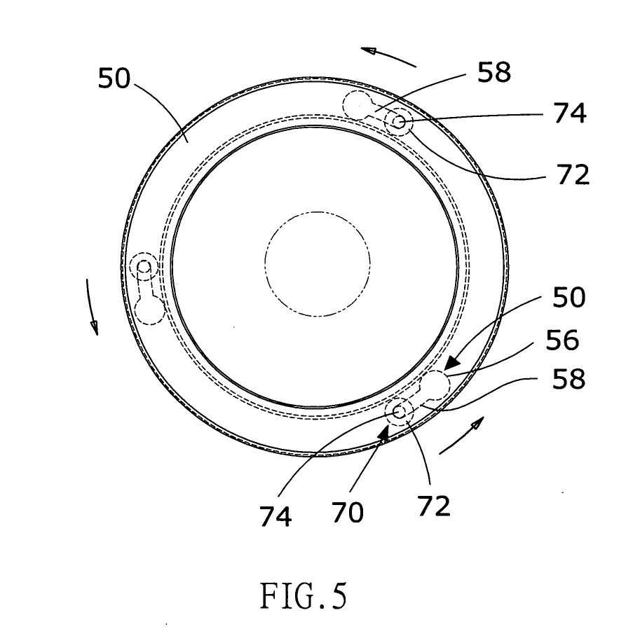

Referring to FIG. 5, the connecting disk 50 is rotatable relative to the positioning disk 30 and the fastening members 70, so that the shank portion 74 of each of the fastening members 70 can be inserted into the locking portion 58 of the respective connecting slot 54 of the connecting disk 50. At this time, the locking portion 58 of each of the connecting slots 54 of the connecting disk 50 has a diameter smaller than that of the head portion 72 of each of the fastening members 70, so that the connecting disk 50 is locked onto the positioning disk 30 by the fastening members 70.

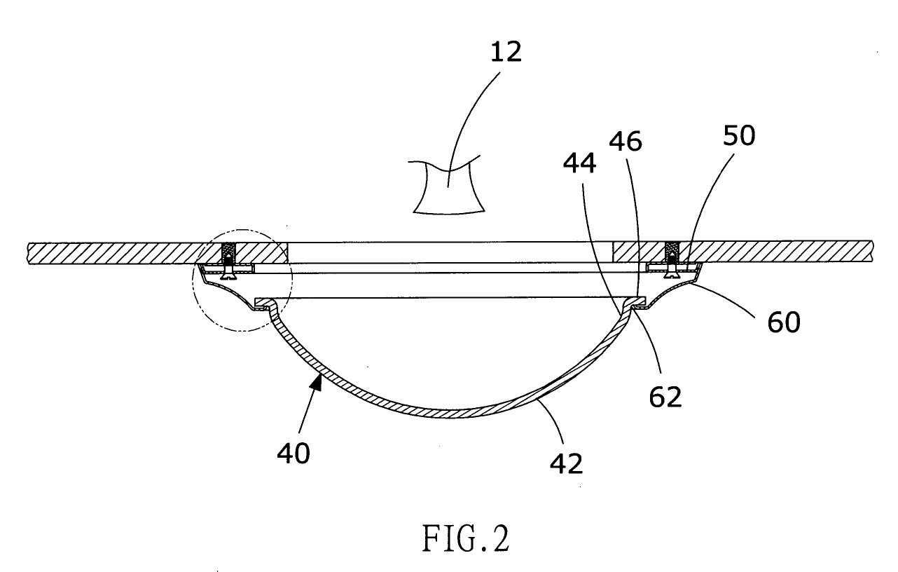

Referring to FIG. 2, the annular lip 46 of the lamp shade 40 is rested on a periphery of the opening 62 of the retaining disk 60, so that the lamp shade 40 is retained by the retaining disk 60.

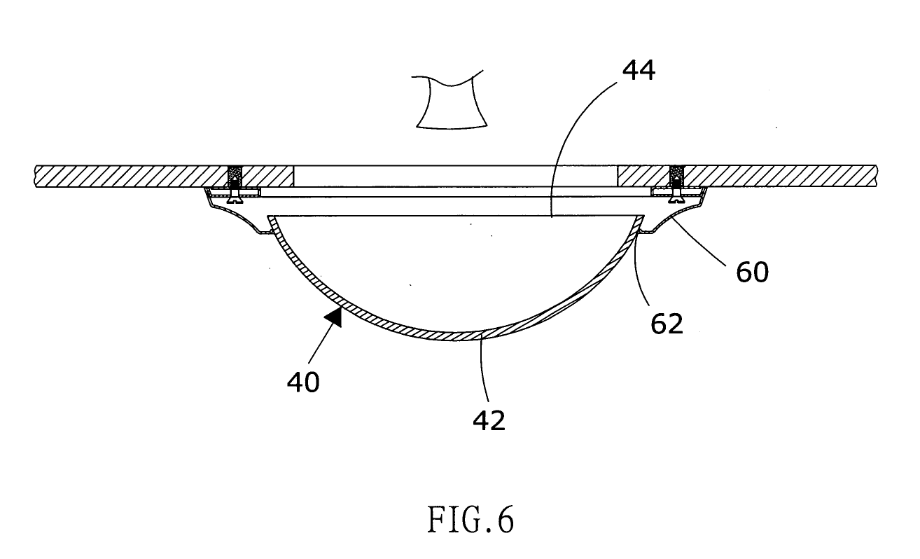

Referring to FIG. 6, the opening structure 44 of the lamp shade 40 has a diameter greater than that of the opening 62 of the retaining disk 60, so that the lamp shade 40 is directly retained by the opening 62 of the retaining disk 60.

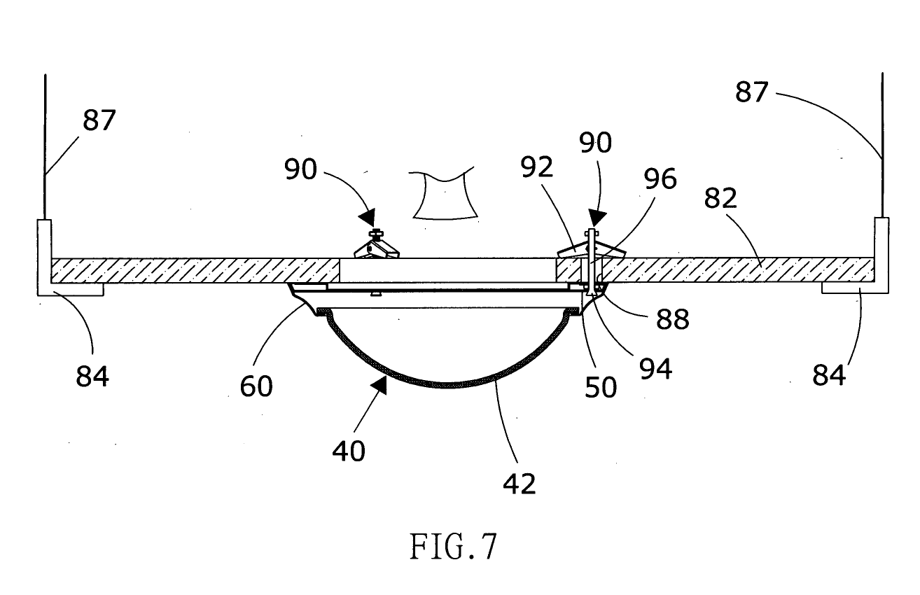

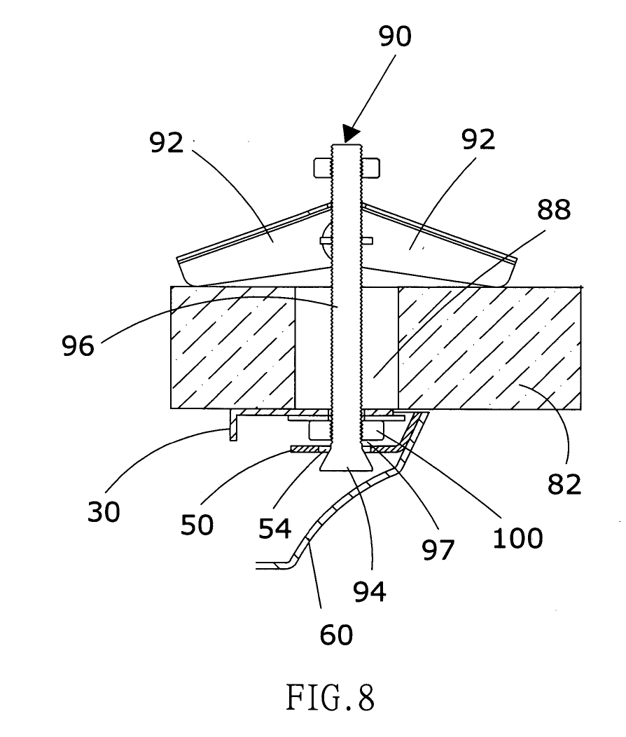

Referring to FIGS. 7 and 8, the wall lamp is mounted on a light steel frame structure which includes two opposite steel frames 84 each suspended by a metallic wire 87, a plaster board 82 mounted between the two opposite steel frames 84 and formed with a plurality of through holes 88, and a plurality of fastening members 90 each mounted on the plaster board 82 and each extended through the respective through hole 88 of the plaster board 82 to connect the connecting disk 50 of the wall lamp. Each of the fastening members 90 is preferably a toggle bolt. Each of the fastening members 90 includes a threaded shank portion 96 extended through the respective through hole 88 of the plaster board 82, a head portion 94 formed on a first end of the shank portion 96 and protruded outward from a lower face of the plaster board 82, two opposite wings 92 each pivotally mounted on a second end of the shank portion 96 and each rested on an upper face of the plaster board 82, and a locking nut 100 screwed onto the first end of the shank portion 96 and rested on the positioning disk 30 to lock the positioning disk 30 onto the lower face of the plaster board 82. A gap 97 is defined between the head portion 94 and the locking nut 100 of each of the fastening members 90. The head portion 94 of each of the fastening members 90 has a diameter greater than that of the shank portion 96.

Referring to FIGS. 7 and 8 with reference to FIG. 1, the receiving portion 56 of each of the connecting slots 54 of the connecting disk 50 has a diameter greater than that of the head portion 94 of the fastening members 90, and the locking portion 58 of each of the connecting slots 54 of the connecting disk 50 has a diameter greater than that of the shank portion 96 of each of the fastening members 90 and smaller than that of the head portion 94 of each of the fastening members 90.

In assembly, when each of the connecting slots 54 of the connecting disk 50 is fitted onto the respective fastening member 90, the receiving portion 56 of each of the connecting slots 54 of the connecting disk 50 aligns with the head portion 94 of the respective fastening members 90, so that the head portion 94 of each of the fastening members 90 can be inserted into the receiving portion 56 of the respective connecting slot 54 of the connecting disk 50.

In operation, the connecting disk 50 is rotatable relative to the positioning disk 30 and the fastening members 90, so that the shank portion 96 of each of the fastening members 90 can be inserted into the locking portion 58 of the respective connecting slot 54 of the connecting disk 50. At this time, the locking portion 58 of each of the connecting slots 54 of the connecting disk 50 has a diameter smaller than that of head portion 94 of each of the fastening members 90, so that the connecting disk 50 is locked onto the positioning disk 30 by the fastening members 90.

Accordingly, the connecting disk is locked onto and detached from the positioning disk by rotating the connecting disk relative to the fastening members, so that the wall lamp is assembled and dismantled easily and rapidly, thereby facilitating a user assembling and disassembling the wall lamp, and thereby saving the working time. In addition, the fastening members are wholly hidden in the retaining disk, thereby enhancing the aesthetic quality of the wall lamp.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A wall lamp, comprising:
a positioning disk secured to a determined surface;
a plurality of fastening members each having a first end formed with a head portion and a second end formed with a shank portion having a diameter smaller than that of the head portion, the shank portion of each of the fastening members being partially extended through the positioning disk and inserted into the determined surface and partially protruded outward from the positioning disk, so that a gap is defined between the head portion of each of the fastening members and the positioning disk;
a connecting disk having a face formed with a plurality of connecting slots each having a first end formed with a receiving portion and a second end formed with a locking portion having a dimension smaller than that of the head portion of each of the fastening members and greater than that of the shank portion of each of the fastening members.

2. The wall lamp in accordance with claim 1, wherein when each of the connecting slots of the connecting disk is fitted onto the respective fastening member, the receiving portion of each of the connecting slots of the connecting disk aligns with the head portion of the respective fastening member, so that the head portion of each of the fastening members can be inserted into the receiving portion of the respective connecting slot of the connecting disk.

3. The wall lamp in accordance with claim 2, wherein the connecting disk is rotatable relative to the positioning disk and the fastening members, so that the shank portion of each of the fastening members can be inserted into the locking portion of the respective connecting slot of the connecting disk.

4. The wall lamp in accordance with claim 3, wherein the locking portion of each of the connecting slots of the connecting disk has a diameter smaller than that of the head portion of each of the fastening members, so that the connecting disk is locked onto the positioning disk by the fastening members.

5. The wall lamp in accordance with claim 1, wherein the positioning disk has an annular shape.

6. The wall lamp in accordance with claim 1, wherein the positioning disk has a central portion formed with a through hole.

7. The wall lamp in accordance with claim 1, wherein the locking portion of each of the connecting slots of the connecting disk has a diameter smaller than that of the receiving portion.

8. The wall lamp in accordance with claim 1, wherein the locking portion of each of the connecting slots of the connecting disk is an elongated hole so that the dimension of the locking portion 58 of each of the connecting slots of the connecting disk is a width in the transverse direction of the elongated hole.

9. The wall lamp in accordance with claim 1, wherein the receiving portion of each of the connecting slots of the connecting disk has a diameter greater than that of the head portion of each of the fastening members.

10. The wall lamp in accordance with claim 1, further comprising a retaining disk combined with the connecting disk and having a central portion formed with an opening.

11. The wall lamp in accordance with claim 10, further comprising a lamp shade having a first end formed with an arc-shaped face and a second end formed with an opening structure mounted in the opening of the retaining disk.

12. The wall lamp in accordance with claim 11, wherein the opening structure of the lamp shade has a periphery formed with a radially and outwardly extending annular lip rested on a periphery of the opening of the retaining disk, so that the lamp shade is retained by the retaining disk.

13. The wall lamp in accordance with claim 11, wherein the opening structure of the lamp shade has a diameter greater than that of the opening of the retaining disk, so that the lamp shade is directly retained by the opening of the retaining disk.

14. The wall lamp in accordance with claim 11, wherein the lamp shade is mounted in a combination of the connecting disk and the retaining disk, and the arc-shaped face of the lamp shade is protruded outward from the opening of the retaining disk.

15. The wall lamp in accordance with claim 10, wherein the connecting disk and the retaining disk are integrally combined together by soldering.

16. The wall lamp in accordance with claim 10, wherein the retaining disk has an annular shape.

17. The wall lamp in accordance with claim 1, wherein the connecting disk has an annular shape and has a central portion formed with an opening.

18. The wall lamp in accordance with claim 1, wherein each of the fastening members is a locking screw.

19. The wall lamp in accordance with claim 1, wherein the each of the fastening members is a toggle bolt.

20. The wall lamp in accordance with claim 1, wherein the determined surface is formed with a plurality of through holes, and each of the fastening members includes a threaded shank portion extended through the respective through hole of the determined surface, a head portion formed on a first end of the shank portion and protruded outward from a lower face of the determined surface, two opposite wings each pivotally mounted on a second end of the shank portion and each rested on an upper face of the determined surface, and a locking nut screwed onto the first end of the shank portion and rested on the positioning disk to lock the positioning disk onto the lower face of the determined surface, and a gap is defined between the head portion and the locking nut of each of the fastening members.
